(19) United States
(12) Patent Application Publication
(10) Pub. No.: US 2010/0124049 A1
(43) Pub. Date: May 20, 2010

(54) LIGHTING SYSTEM

(76) Inventor: Jose Fabian, Canoga Park, CA (US)

Correspondence Address: Intellipex PLLC, 30200 Telegraph Road, Suite 245, Bingham Farms, MI, 48025, US

(21) Appl. No.: 12/610,568

(22) Filed: Nov. 2, 2009

Related U.S. Application Data
(60) Provisional application No. 61/114,802, filed on Nov. 14, 2008.

(51) Int. Cl. F21V 21/08

(52) U.S. Cl. 362/108

(57) ABSTRACT

One embodiment of a lighting system for a rider of a vehicle may include a garment configured to be worn on a torso of the rider. The garment may have a front portion and a rear portion. The rear portion may include a first side section, a second side section, and a center section. Further, the lighting system may include one or more controllers carried by the vehicle, and configured to generate a running signal, a brake signal, a left turn signal, and a right signal. The lighting system may also include a first light emitter, a second light emitter and a third light emitter that are associated with the controllers.

### CROSS REFERENCE TO RELATED APPLICATION

This application claims the benefit of U.S. Provisional Application No. 61/114,802 filed on Nov. 14, 2008 the disclosure of which is incorporated by reference.

### FIELD OF THE DISCLOSURE

The present disclosure generally relates to lighting systems for riders of motorcycles or other exposed vehicles, and more particularly, to a lighting system configured for a garment that may be worn by a rider of an exposed vehicle.

### BACKGROUND OF THE DISCLOSURE

Motorcycling and riding bicycles are common modes of transportation. However, riders of such exposed vehicles may be prone to accidents and may therefore be vulnerable road travelers who are not seen by motorists of cars and trucks, particularly in conditions of poor visibility. Accordingly, the riders may have an increased risk of collisions with the other motorists.

Various devices have been developed to prevent accidents related to motorcycles or other exposed vehicles. For example, a reflective tape may be attached to clothing of a rider to increase the rider's visibility to other motorists. However, the reflective tape may seem unattractive to many riders and may also damage the clothing.

### SUMMARY OF THE DISCLOSURE

One embodiment of a lighting system for a rider of a vehicle may include a garment configured to be worn on a torso of the rider. The garment may include a front portion and a rear portion. The rear portion may include a first side section, a second side section, and a center section disposed between the first and second side sections. The lighting system may further include one or more controllers carried by the vehicle. The controllers may be configured to generate a running signal, a brake signal, a left turn signal and a right signal. The lighting system may also include a first light emitter carried by the center section of the rear portion. The first light emitter may be associated with the controllers to receive the running signal and the brake signal therefrom. Further, the first light emitter may produce a first illumination in response to one of the running signal and the brake signal. The lighting system may also include a second light emitter carried by the first side section and spaced apart from the first light emitter. The second light emitter may be associated with the controllers to receive the left turn signal therefrom. Further, the second light emitter may produce a second illumination in response to the left turn signal. Moreover, the lighting system may include a third light emitter carried by the second side section and spaced apart from the first light emitter and the second light emitter. The third light emitter may be associated with the controllers to receive the right turn signal therefrom. Further, the third light emitter may produce a third illumination in response to the right turn signal.

### BRIEF DESCRIPTION OF THE DRAWINGS

These and other features and advantages of the present disclosure will be apparent from the following detailed description of preferred embodiments and best mode, appended claims, and accompanying drawings in which:

FIG. 1 is a perspective view of one embodiment of a lighting system including a garment worn by a rider of a motorcycle;

FIG. 2 is a rear view of the garment of FIG. 1;

FIG. 3 is a cross sectional view taken along line 3-3 of FIG. 2;

FIG. 4 is a front view of the garment of FIG. 1;

FIG. 5 is a block diagram of the lighting system of FIG. 1, illustrating the lighting system having various components and the interconnections therebetween;

FIG. 6 is a perspective view of another embodiment of a lighting system including one or more controllers carried by a vehicle and one or more light emitters wirelessly communicating with the controllers; and

FIG. 7 is a block diagram illustrating association of various components of the lighting system of FIG. 6.

Like reference numerals refer to like parts throughout the description of the drawings.

### DETAILED DESCRIPTION OF THE DISCLOSURE

The exemplary embodiments described herein in detail for illustrative purposes are subject to many variations in structure and design. It should be emphasized, however, that the present disclosure is not limited to a particular lighting system, as shown and described. It is understood that various omissions and substitutions of equivalents are contemplated as circumstances may suggest or render expedient, but these are intended to cover the application or embodiment without departing from the spirit or scope of the claims of the present disclosure. Also, it is to be understood that the phraseology and terminology used herein are for the purpose of description and should not be regarded as limiting.

The use of “including,” “comprising,” or “having” and variations thereof herein is meant to encompass the items listed thereafter and equivalents thereof as well as additional items. Further, the term “first,” “second,” and the like, herein do not denote any order, elevation or importance, but rather are used to distinguish placement of one element over another. Further, the terms, “a” and “an” herein do not denote a limitation of quantity, but rather denote the presence of at least one of the referenced item. Unless limited otherwise, the term “coupled” and variations thereof herein are used broadly and encompass direct and indirect couplings.

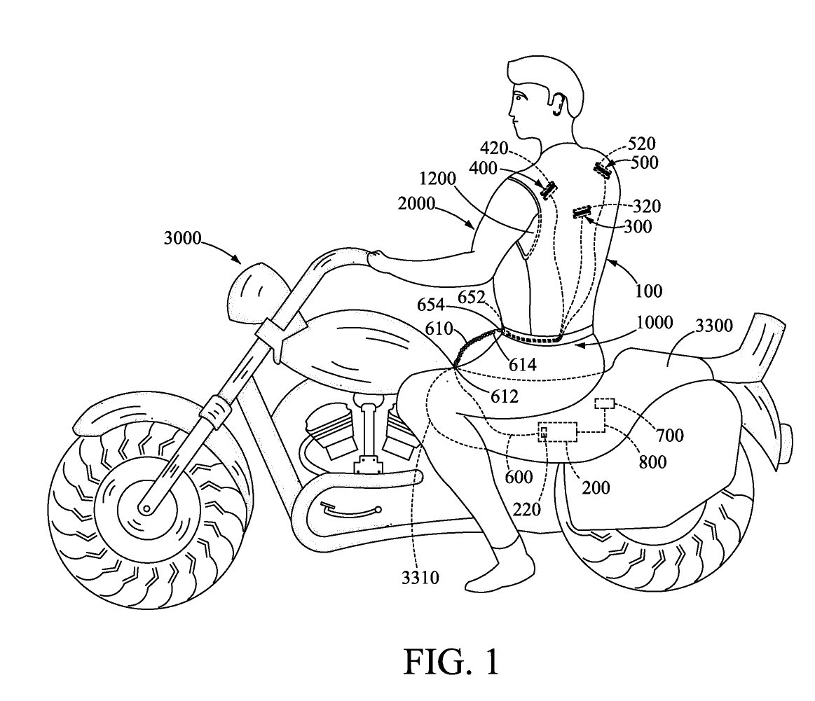

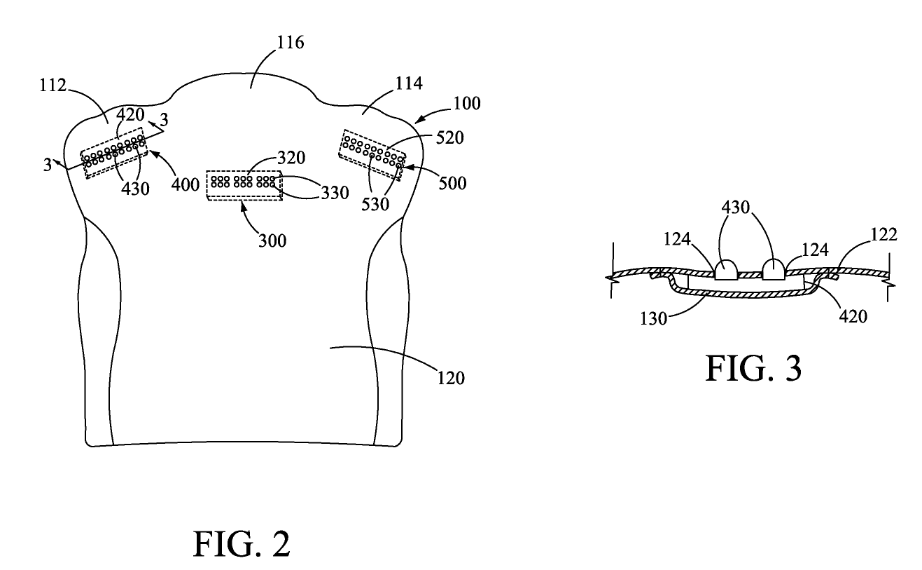

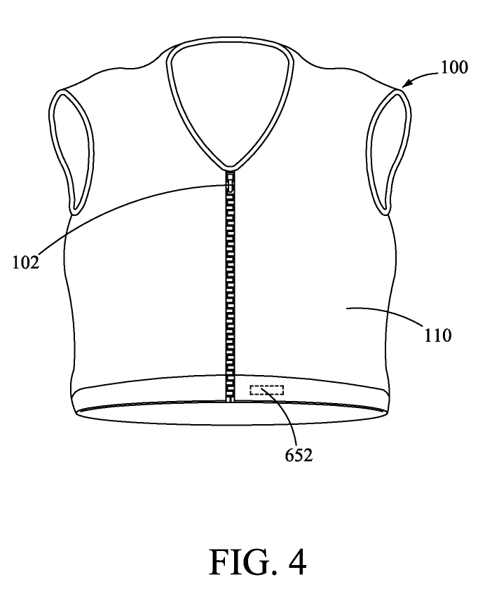

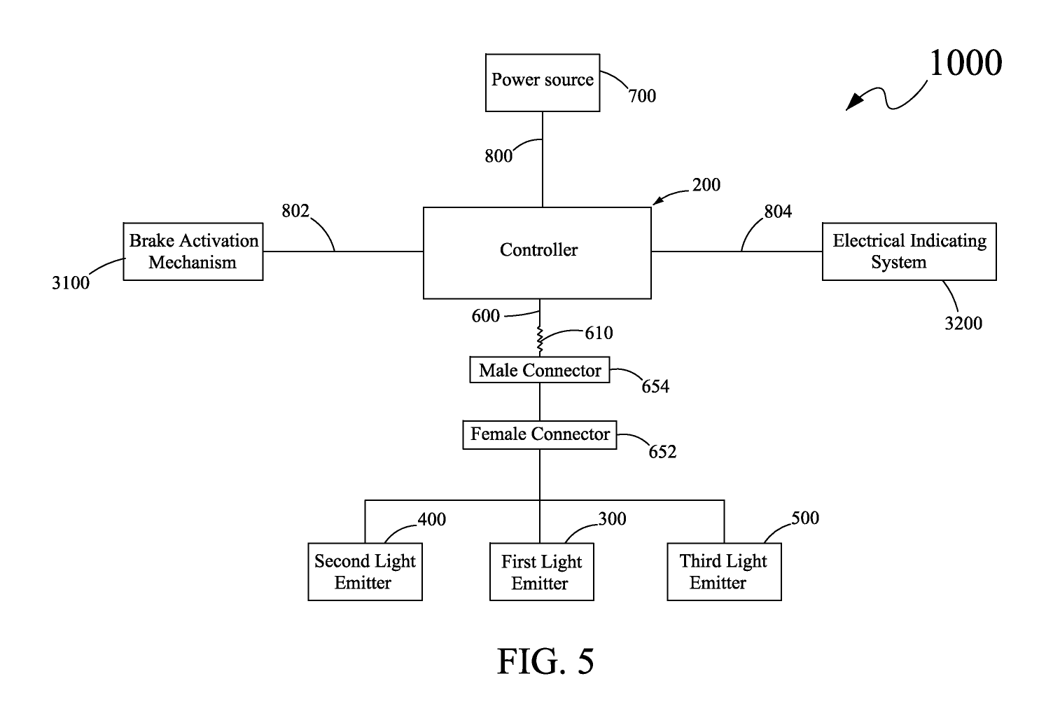

Referring to FIGS. 1-5, a lighting system 1000 may include a garment 100 configured to be worn by a rider 2000 of a vehicle 3000. The term, “vehicle” relates to a motorcycle or any other exposed vehicle such as a bicycle. For the purpose of the description, the vehicle 3000 is a motorcycle. The garment 100 may have a front portion 110 and a rear portion 120. The rear portion 120 may include an outer layer 122 having a first side section 112, a second side section 114, and a center section 116 disposed between the first and second side sections 112, 114. As best shown in FIG. 3, the first side section 112 may have a first plurality of holes 124. Similarly the second side section 114 may have a second plurality of holes similar to the first plurality of holes 124. In addition, the center section 116 may have a third plurality of holes similar to the first plurality of holes 124. Each section 112, 114 and 116 may have eighteen holes. Of course, the each section 112, 114 and 116 may have more or less than eighteen holes. The rear portion 120 may also have one or more inner layers 130 carried by the outer layer 122 and disposed adjacent to the holes 124.

The garment 100 may also include a fastener 102 carried by the front portion 110 for attaching the two halves of the front portion 110 together in order to secure the garment 100 on a torso 1200 of the rider 2000. The fastener 102 may be a zipper. Alternately, the fastener 102 may be a hook and loop fastener, a snap fit fastener, or any other fastener known in the art for closing the two halves of the front portion 110. The garment 100 is shown to be a sleeve-less and collarless vest. Alternately, the garment 100 may include a first sleeve portion and a second sleeve portion, and an optional collar portion.

The lighting system 1000 may further include one or more controllers 200 carried by the vehicle 3000. The controllers 200 may be associated with a variety of actuators, such as an ignition, a brake, a left turn indicator, and a right turn indicator. Of course, the controllers 200 may also be associated with sensors, such as motion sensors, direction sensors, and the like. More specifically, the controllers 200 may be electrically coupled to a brake activation mechanism 3100 of the vehicle 3000 via a wire 802. The brake activation mechanism 3100 may include a brake lever. Moreover, the controllers 200 may also be electrically coupled with an electrical indicating system 3200 of the vehicle 3000 via a wire 804. The electrical indicating system 3200 may control the illumination of vehicular signals, including running and brake lights, and right and left turn indicators of the vehicle 3000. The controllers 200 may be configured to generate a running signal, a brake signal, a left turn signal, and a right signal in response to, for example, a rider actuating a respective one of the ignition, the brake lever, the left turn indicator, and the right turn indicator. Further, the controllers 200 may include a transmitter 220 for transmitting the running signal, the brake signal, the left turn signal, and the right turn signal. The controllers 200 may also include one or more switches (not shown) for performing different functions, such as, activation/deactivation, selecting frequency transmission, transmitting signals, selecting appropriate transmission intensity, monitoring signal strength, and the like.

The lighting system 1000 may further include a wire harness 600 extending from the controllers 200. The wire harness 600 may be carried by the vehicle 3000 and covered by or disposed underneath a seat 3300 of the vehicle 3000. Further, the lighting system 1000 may also have a resilient coil cord 610 that may have one end 612 that may be operably connected to the wire harness 600 adjacent to a front end 3310 of the vehicle seat 3000. The cord 610 may have another end 614 that may include an electrical connector, such as a male connector 654.

Furthermore, the lighting system 1000 may include a first light emitter 300 carried by the center section 116 of the rear portion 120 of the garment 100. The first light emitter 300 may be associated with the controllers 200 to receive the running signal and the brake signal therefrom. Specifically, the first light emitter 300 may be electrically coupled to a female connector 652 that may be capable of receiving the male connector 654 for receiving the running signal and the brake signal from the controllers 200. Accordingly, the first light emitter 300 may be electrically interconnected with the controllers 200 via the wire harness 600 and the cord 610 extending from underneath the front end 3310 of the seat 3300 of the vehicle 3000. The female connector 652 in one form may be at least partially covered by a portion of the garment 100. The first light emitter 300 may produce a first illumination in response to the running signal or the brake signal. For example, the first light emitter 300 may emit a red light or other suitable colored light at a first luminous intensity in response to the running signal, and a red light or other suitable colored light at a second luminous intensity that is greater than the first luminous intensity in response to the brake signal.

The first light emitter 300 may include a housing 320 or a plastic board that may be carried by the center section 116 of the garment 100 and disposed between the inner and outer layers 130, 122. The first light emitter 300 may also have one or more light emitting diodes 330 (LEDs) carried by the housing 320 and extending through the third plurality of holes. The first light emitter 300 in this form may include about eighteen LEDs 330. Alternately, the first light emitter 300 may instead include any number of LEDs, incandescent bulbs, neon lights, or any other light.

The lighting system 1000 may also include a second light emitter 400 carried by the first side section 112 and spaced apart from the first light emitter 300. The second light emitter 400 may be associated with the controllers 200 to receive the left turn signal therefrom. Specifically, the second light emitter 400 may be electrically coupled to the female connector 652, which may be capable of receiving the male connector 654 to receive the left signal from the controllers 200. Accordingly, the second light emitter 400 may be electrically interconnected with the controllers 200 via the wire harness 600 and the cord 610. The second light emitter 400 may produce a second illumination in response to the left turn signal. For example, the second light emitter 400 may intermittently emit yellow light or other suitable colored light in response to the left turn signal.

The second light emitter 400 may include a housing 420 or a plastic board that may be carried by the first side section 112 of the garment 100 and disposed between the inner and outer layers 130, 122. The second light emitter 400 may also have one or more LEDs 430 carried by the housing 420 and extending through the holes 124. The second light emitter 400 in this form may include about eighteen LEDs 430. Of course, the second light emitter 400 may include any number of LEDs, incandescent bulbs, neon lights, or any other light.

In addition, the lighting system 1000 may also include a third light emitter 500 carried by the second side section 114, and spaced apart from the first light emitter 300 and the second light emitter 400. The third light emitter 500 may be electrically coupled to the female connector 652, which may be capable of receiving the male connector 654 to receive the right signal from the controllers 200. Accordingly, the third light emitter 500 may be electrically interconnected with the controllers 200 via the wire harness 600 and the cord 610. The third light emitter 500 may produce a third illumination in response to the right turn signal. For example, the third light emitter 500 may intermittently emit yellow light or other suitable colored light in response to the right turn signal.

The third light emitter 500 may include a housing 520 or a plastic board that may be carried by the second side section 114 of the garment 100 and disposed between the inner and outer layers 130, 122. The third light emitter 500 may also have one or more LEDs 530 carried by the housing 520 and extending through the second plurality of holes. The third light emitter 500 in this form may include about eighteen LEDs 530. Of course, the third light emitter 500 may include any number of LEDs, incandescent bulbs, neon lights or any other light.

The second light emitter 400 and the third light emitter 500 may be operated separately, irrespective of each other. However, the second light emitter 400 and/or the third light emitter 500 may be operated in combination with the first light emitter 300.

The lighting system 1000 may also include a power source 700 carried by the vehicle 3000 and electrically coupled with the controllers 200 through a wire 800. The wire 800 may be a wire harness of the vehicle 3000. Specifically, the controllers 200 may be hardwired with the power source 700. The power source 700 may include one or more batteries, such as a rechargeable battery. Of course, the power source 700 may include one or more solar cells capable of receiving solar energy and converting the solar energy into electrical current. The controllers 200 may be activated by power supplied by the power source 700. Therefore, the controllers 200 may have the capability to interface with the vehicle 3000, when appropriate, for power requirements. The power source 700 may also provide power to the first, second and third light emitters 300, 400, 500.

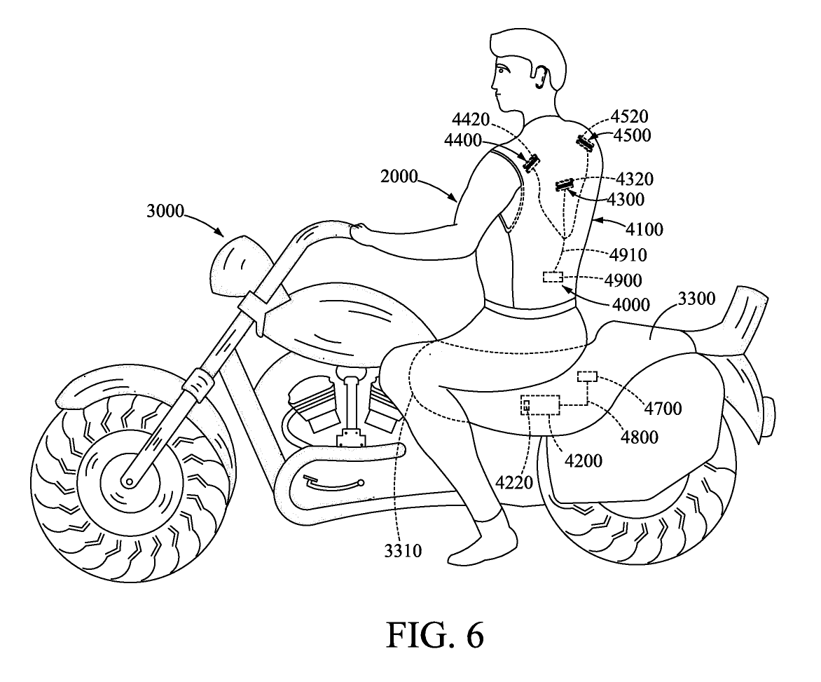

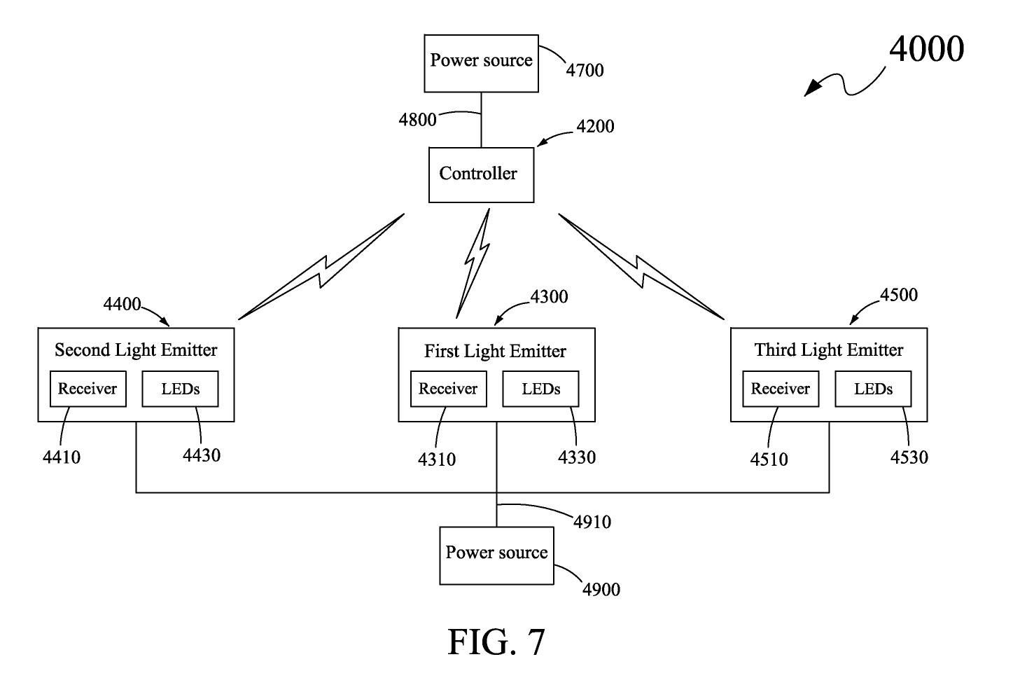

Referring to FIGS. 6 and 7, another embodiment of a lighting system 4000 may include a power source 4900 that may be carried by the garment 4100, and operatively coupled to first, second and third light emitters 4300, 4400, 4500 via an electrical means 4910.

The lighting system 4000 may be similar to the lighting system 1000. Further, the lighting system 4000 may include one or more controllers 4200, which may be similar to the controllers 200, and may be carried by the vehicle 3000. The controllers 4200 may be associated with a power source, such as a power source 4700, of the vehicle 6000 via a wire 4800 for activation thereof, similar to the controllers 200. The controllers 4200 may be configured to generate a running signal, a brake signal, a left turn signal, and a right signal in response to, for example, a rider actuating a respective one of an ignition, a brake, a left turn indicator, and a right turn indicator. Further, the controllers 4200 may include a transmitter 4220 for transmitting the running signal, the brake signal, the left turn signal, and the right turn signal. In addition, the controllers 4200 may be electrically coupled with a brake activation mechanism of a vehicle. Moreover, the controllers 4200 may also be electrically coupled with an electrical indicating system of the vehicle, similar to the controllers 200.

However, each of the first, second and third light emitters 4300, 4400, 4500 may be wirelessly connected with the controllers 4200. Specifically, the each of the first, second and third light emitters 4300, 4400, 4500 may be wirelessly connected with the controllers 4200 by, for example, BLUETOOTH technology, an infrared technology or other wireless technology.

The first light emitter 4300 may include a first receiver 4310 carried by a housing 4320. The receiver 4310 may be adapted to wirelessly receive the running signal and the brake signal from the controllers 4200. The first light emitter 4300 may produce a first illumination in response to the running signal and the brake signal. Specifically, the first light emitter 4300 may include one or more light emitting diodes 4330 for producing the first illumination.

Further, the second light emitter 4400 may include a receiver 4410 carried by a housing 4420. The receiver 4410 may be adapted for wirelessly receiving the left turn signal from the controllers 4200. The second light emitter 4400 may produce a second illumination in response to the left turn signal. Specifically, the second light emitter 4400 may include one or more light emitting diodes 4430 for producing the second illumination.

Furthermore, the third light emitter 4500 may include a third receiver 4510 carried by a housing 4520. The receiver 4510 may be adapted for wirelessly receiving the right turn signal from the controllers 4200. The third light emitter 4500 may produce a third illumination in response to the right turn signal. Specifically, the third light emitter 4500 may further include one or more light emitting diodes 4530 for producing the third illumination.

In use, the garment 100 of the lighting system 1000 may be worn by the rider 2000 of the vehicle 3000. The power source 700 may supply power to the controllers 200, which may then activate in response to actuating different parts, such as the ignition, brake lever, the left turn and the right turn indicators, of the vehicle 3000. Accordingly, the transmitter 220 of the controllers 200 may transmit the running signal, the brake signal, the left turn signal and the right turn signal, depending on the requirement.

The rider 2000 may also actuate the brake lever, and the controllers 200 may generate the brake signal in response to actuation of the brake lever. The transmitter 220 may then transmit the brake signal from the controllers 200 to the first light emitter 300 to induce the first light emitter 300 to emit, for example, red light at the second luminous intensity to signify that the rider 2000 has applied brake to decelerate the vehicle 3000. In addition, the rider 2000 may release the brake lever, and the controllers 200 may generate the running signal in response to release of the brake lever. The transmitter 220 may then transmit the running signal from the controllers 200 to the first light emitter 300 to induce the first light emitter 300 to emit, for example, red light at the first luminous intensity to signify that the vehicle 3000 is in a running mode.

Furthermore, the rider 2000 may actuate the left turn indicator of the electrical indicating system 3200 of the vehicle 3000, and the controllers 200 may generate the left turn signal in response to actuation of the left turn indicator. The transmitter 220 may then transmit the left turn signal from the controllers 200 to the second light emitter 400 to induce the second light emitter 400 to intermittently emit yellow light to signify that the rider 2000 intends to make a left turn. Similarly, the rider 2000 may actuate the right turn indicator of the vehicle 3000, and the controllers 200 may generate the right turn signal in response to actuation of the right turn indicator. The transmitter 220 may then transmit the right turn signal from the controllers 200 to the third light emitter 400 to induce the third light emitter 400 to intermittently emit yellow light to signify that the rider 2000 intends to make a right turn.

In addition, the rider 2000 may also actuate the brake mechanism of the vehicle 3000, and the controllers 200 may generate the brake signal based on actuation of the brake mechanism. The transmitter 220 may then transmit the brake signal from the controllers 200 to the first light emitter 300 to induce the first light emitter 300 to emit red light or other suitable colored light at the second luminous intensity to signify that the rider 2000 is actuating the brake mechanism. Further, the rider 2000 may release the brake mechanism, and the controllers 200 may generate the running signal based on the release of the brake mechanism. The transmitter 220 may then transmit the running signal from the controllers 200 to the first light emitter 300 to induce the first light emitter 300 to emit red light or other suitable colored light at the first luminous intensity to signify that the vehicle 3000 is in a running mode.

It should be evident that the lighting system 4000 may be utilized in the above manner as described for the lighting system 1000. Accordingly, a description thereof has been avoided for the sake of brevity.

The present disclosure provides a lighting system, such as the lighting systems 1000 and 4000, for a rider of an exposed vehicle, such as a motorcycle. The lighting system enhances visibility of other motorists to recognize the rider and to indicate the other motorists about the rider's intentions. The first light emitter, the second light emitter and the third light emitter give off light signals that may be seen by other motorists in order to avert the occurrence of an accident.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A lighting system for a rider of a vehicle, the lighting system comprising:
a garment configured to be worn on a torso of the rider, the garment having a front portion and a rear portion, the rear portion having a first side section, a second side section, and a center section disposed between the first side section and the second side section;
at least one controller carried by the vehicle, the at least one controller being configured to generate a running signal, a brake signal, a left turn signal, and a right signal;
a first light emitter carried by the center section of the rear portion of the garment, the first light emitter being associated with the at least one controller, wherein the first light emitter produces a first illumination in response to one of the running signal and the brake signal;
a second light emitter carried by the first side section and spaced apart from the first light emitter, the second light emitter being associated with the at least one controller, wherein the second light emitter produces a second illumination in response to the left turn signal; and
a third light emitter carried by the second side section and spaced apart from the first light emitter and the second light emitter, the third light emitter being associated with the at least one controller, wherein the third light emitter produces a third illumination in response to the right turn signal.

2. The lighting system of claim 1, wherein the first light emitter emits light at a first luminous intensity in response to the running signal and the light at a second luminous intensity in response to the brake signal, the second luminous intensity being greater than the first luminous intensity.

3. The lighting system of claim 1, wherein the at least one controller comprises a transmitter for transmitting the running signal, the brake signal, the left turn signal, and the right turn signal.

4. The lighting system of claim 3, wherein the first light emitter comprises a first receiver for receiving the one of the running signal and the brake signal from the transmitter.

5. The lighting system of claim 4, wherein the first receiver is a wireless receiver.

6. The lighting system of claim 4, wherein the first light emitter emits light at a first luminous intensity on receiving the running signal and light at a second luminous intensity on receiving the brake signal, the second luminous intensity being greater than the first luminous intensity.

7. The lighting system of claim 3, wherein the second light emitter comprises a second receiver for receiving the left turn signal from the transmitter.

8. The lighting system of claim 7, wherein the second receiver is a wireless receiver.

9. The lighting system of claim 3, wherein the third light emitter comprises a third receiver for receiving the right turn signal from the transmitter.

10. The lighting system of claim 9, wherein the third receiver is a wireless receiver.

11. The lighting system of claim 1, further comprising a power source carried by one of the vehicle and the garment of the lighting system.

12. The lighting system of claim 11, wherein the power source comprises at least one battery.

13. The lighting system of claim 1, wherein each of the first light emitter, the second light emitter and the third light emitter, comprises a power source for supplying power.

14. The lighting system of claim 13, wherein the power source comprises at least one battery.

15. The lighting system of claim 1, further comprising a wire harness carried by the vehicle and covered by a seat of the vehicle, and a resilient coil cord adapted to be connected to the wire harness, and to the first, second and third light emitters.
